(19) United States
(12) Patent Application Publication
(10) Pub. No.: US 2009/0047002 A1
(43) Pub. Date: Feb. 19, 2009

(54) DATA PROCESSING APPARATUS AND DATA PROCESSING METHOD, AND COMPUTER PROGRAM

(75) Inventors: Naoki Morimoto, Tokyo (JP); Kenichiro Aridome, Kanagawa (JP); Yukio Isobe, Kanagawa (JP); Atsushi Mae, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/092,779

(22) PCT Filed: Jul. 30, 2007
(86) PCT No.: PCT/JP2007/064888

§ 371 Date: May 6, 2008

(30) Foreign Application Priority Data
Sep. 13, 2006 (JP) 2006-248014

(51) Int. Cl. H04N 5/00

(52) U.S. Cl. 386/125; 386/E09.001

(57) ABSTRACT

A movie stream recorded on a recording medium with accompanying management information according to a predetermined standard format is edited while satisfying an upper limit condition.

When the number of play items or the number of playlist marks in a playlist has reached or approached the upper limit condition, last chapter information in the playlist is moved to the beginning of a subsequent playlist or a newly created playlist. Furthermore, in a case where there exists a margin against the upper limit condition regarding the number of play items or the number of playlist marks as one playlist even if contents of two or more adjacent playlists are combined, the playlists are integrated to reduce the number of playlists on the recording medium.

### TECHNICAL FIELD

The present invention relates to data processing apparatuses and data processing methods and computer programs for executing processing such as recording or playing of data. Particularly, the present invention relates to data processing apparatuses and wireless communication methods and computer programs for executing processing such as recording of a movie stream picked up by a digital video camera onto a recording medium or editing of the movie stream.

More specifically, the present invention relates to data processing apparatuses and data processing methods and computer programs for executing processing for editing a movie stream recorded on a recording medium together with accompanying management information according to a predetermined standard format, and relates to data processing apparatuses and data processing methods and computer programs for repeatedly editing a movie stream recorded on a recording medium in a complex folder structure according to a predetermined format, in consideration of various types of upper limit conditions.

### BACKGROUND ART

Disk-type recording media in which optical reading is applied, such as DVD (Digital Versatile Disk) and CD (Compact Disk), are rapidly coming to be used commonly for saving a relatively large volume of files or a huge number of files. Optical disks have large storage capacities, and allow random access.

Recording/playing apparatuses that use optical disks are already in common use, for example, as external recording media and external storage devices for computers. Recently, in accordance with the increase in the recording capacities of disk-type recording media, video cameras of the type that saves movies on a disk instead of on a recording tape as in existing art (e.g., refer to Patent Document 1) have appeared. For example, DVD video cameras, since their release in the year 2000, are coming to be used by an increasing number of users year by year due to favorable image quality and usability such as support for editing.

For example, the AVCHD standard, while inheriting contents of existing disk format standards as appropriate, defines specification regarding a data format and so forth for video cameras having high resolutions (High Definition: HD) by adding recording compatibility and additional recording compatibility functions. The AVCHD standard employs the MPEG-4 AVC/H.264 scheme, having a high compression rate, and its main object is to allow recording of HD images on a low-capacity low-speed recording medium. Although recording on DVD disks is assumed, it is possible to perform recording on various recording media, such as memory cards or HDDs, according to the AVCHD standard format (e.g., refer to Non-Patent Document 1 and Non-Patent Document 2).

In the AVCHD standard, MPEG (Moving Picture Experts Group)-2 System has already been determined as the movie stream file format. However, the standard format has a complex file structure in which in addition to saving a stream file alone on a recording medium, a plurality of accompanying management information files for playing or editing the movie files are saved. When movie content is encoded as an MPEG2-TS stream, a set of data forming a unit that needs to be played in such a manner that continuous synchronous playing, i.e., real-time playing, is ensured constitutes one clip (Clip), i.e., a clip AV stream (ClipAVStream) file. When this clip AV stream file is recorded on a recording medium, management information files of the types called a playlist (PlayList) file and a clip information (ClipInformation) file are recorded in accompany therewith.

The clip information file is a file that exists as a pair with a clip AV stream file and in which information regarding a stream, needed to play an actual stream, is described. A playlist can register play segments and play order of movie data by registering play items (PlayItem) describing play segments formed of play start points (IN points) and play end points (OUT points) for clips and arranging a plurality of play items in order of time. Furthermore, in the playlist, it is possible to insert a playlist mark (PlayListMark) as an entry point for access to the stream by the user. A segment defined by adjacent entry marks constitutes a minimum editing unit visible to the user, i.e., a “chapter”. Furthermore, a recording editing function can be realized suitably by using management information files such as clip information and playlists.

Furthermore, in the AVCHD standard, as attributes of a playlist, in addition to real playlists (Real PlayList) having bodies of content (i.e., clip AV streams), virtual playlists (Virtual PlayList) not having bodies of content are defined. For a recording application, it is desired for user's convenience that editing of content that has been picked up is allowed. Editing of a real playlist is editing of the body of content, i.e., destructive editing involving change in components themselves on a recording medium. In contrast, editing of a virtual playlist only redefines play start points and play end points for a clip AV file, so that non-destructive editing allowed, which does not alter the body of content itself.

As non-destructive or destructive editing is performed repeatedly on a movie stream recorded on a recording medium, the number of files existing on the recording medium increases. Here, in many embedded devices such as digital cameras, due to filename naming rules or the like, upper limit conditions are provided on the number of files or the number of folders that can be created on a single recording medium, or an upper limit condition is provided on the number of files that are stored in a specific folder. By setting these types of upper limit conditions, for example, it is possible to achieve an advantage that the number of files existing on the same path is kept small so that reduction in access speed is prevented.

However, if such upper limit conditions are set in the standard format, the number of files can reach an upper limit in the course of editing content recorded on a recording medium. In such cases, editing exceeding the upper limit is not allowed even though the recording medium has a remaining capacity.

For example, in a digital camera that has been proposed, in a case where an upper limit number of image files is set on the number of image files that can be recorded in a single recording folder, in a mode in which image pickup is performed once, if the number of image files in a current recording folder exceeds the upper limit number of image files, the current recording folder is changed to another recording folder, whereas in a mode in which image pickup is performed a plurality of times associated with each other, the current recording folder is maintained to be the same from the recording of image data associated with the first image pickup among the plurality of times of image pickup to recording of image data associated with the last image pickup (e.g., refer to Patent Document 2). According to this type of digital camera, searching of an image file after recording is facilitated while maintaining favorable operability.

Furthermore, in a file management apparatus that has been proposed, in a case where a file system having a directory system is used, in a case where the number of files that should exist in a directory specified from outside by a path name exceeds a predetermined number, one or two or more subdirectories are created under the original directory, and management is exercised internally to assign the plurality of files that should exist in the original directory to the plurality of subdirectories so that the number of files entered in each directory is within the predetermined upper limit number, thereby alleviating reduction in access speed due to the increase in the number of files existing on the same path (e.g., refer to Patent Document 3).

However, in a complex standard format, such as the AVCHD standard, various types of upper limit conditions are set, so that in some cases, it is not possible to deal with the upper limit conditions simply by changing the recording folder. Thus, in the course of editing recording content, the number of files can reach the upper limit and, for example, the following problems can occur.

(1) Due to upper limit restrictions within a single playlist, further editing is not allowed.

(2) Unused numbers for file names become exhausted, so that further editing is not allowed.

In a case where the upper limit of the number of play items is reached as a result of repeating editing a movie stream within a single playlist, even if an attempt is made to create a new playlist and add a play item, it is possible that the number of playlists has already been exhausted. In this case, such a solution as changing the folder does not work.

### Patent Document 1:

### Japanese Unexamined Patent Application Publication No. 2004-Patent Document 2:

### Japanese Unexamined Patent Application Publication No. 2005-Patent Document 3:

### Japanese Unexamined Patent Application Publication No. 2005-Non-Patent Document 1:

http://www.avchd-info.org/

### Non-Patent Document 2:

http://support.d-imaging.sony.co.jp/www/handycam/products/be nri/avchd/index.html

### DISCLOSURE OF INVENTION

### Technical Problem

It is an object of the present invention to provide a favorable data processing apparatus and data processing method and computer program with which it is possible to suitably execute processing for editing a movie stream recorded on a recording medium in accompany with management information according to a predetermined standard format.

It is another object of the present invention to provide a favorable data processing apparatus and data processing method and computer program with which it is possible to repeatedly execute operations for editing a movie stream recorded on a recording medium in a complex folder structure according to a predetermined standard format, in consideration of various types of upper limit conditions.

### Technical Solution

The present invention has been made in view of the problems described above, an aspect thereof is a data processing apparatus for editing a movie stream recorded on a recording medium according to a predetermined standard format, characterized in that:

the recording medium has recorded thereon one or more playlist files accompanying a clip movie stream file, the playlist files including chapter information formed of play segments of the clip movie stream and entry points for access to the clip movie stream file by a user, and

the data processing apparatus comprises

managing means for managing an upper limit condition regarding the playlist files, the upper limit condition being defined in the predetermined standard format; and

editing means for editing the playlist files so that the upper limit condition is reduced.

The AVCHD standard has been defined mainly aiming at allowing recording of high-definition video signals on low-capacity low-speed recording media. According to the AVCHD standard format, it is possible to perform recording on various recording media, such as DVD disks, memory cards, and HDDs.

In the AVCHD standard, MPEG-2 System has already been determined as the movie stream file format. However, it defines a media recording format having a complex file structure in which in addition to saving a stream file alone on a recording medium, a plurality of accompanying management information files for playing or editing the movie files are saved. Furthermore, in the AVCHD standard, as attributes of playlists, in addition to real playlists having bodies of content, virtual playlists not having bodies of content are defined. Non-destructive editing is allowed by only redefining play starts points and play end points for a clip AV file using a virtual playlist.

In many existing standard formats defining methods of recording files on recording media, upper limit conditions are set on the number of files or the number of folders that can be created on a single recording medium, according to filename naming rules or the like. Thus, the number of files can reach the upper limit in the course of editing content recorded on a recording medium so that further editing operations are not allowed even though the recording medium has a remaining capacity.

Thus, in the data processing apparatus according to the present invention, when data recorded on a recording medium is edited according to the AVCHD standard, playlists are organized so that the problem described above is alleviated.

For example, when the number of play items or the number of playlist marks in a playlist has reached or approached the upper limit condition, processing for moving the last (or a predetermined number of from the last) chapter information to the beginning of a subsequent playlist is executed.

Furthermore, as a result of executing processing for moving the last (or a predetermined number of from the last) chapter information in a playlist to the beginning of a subsequent playlist, in a case where the number of play items or the number of playlist marks in the subsequent playlist reaches the upper limit condition, similar processing can be executed repeatedly to move extra chapter information to a further subsequent playlist.

Alternatively, when the number of play items or the number of playlist marks in a playlist has reached or approached the upper limit condition, processing for moving the last (or a predetermined number of from the last) chapter information to the beginning of a new playlist may be executed. Regarding the play order on the recording medium, the new playlist herein is provided in an interval with an existing subsequent playlist.

Furthermore, in the AVCHD standard, it is defined that numbers for file names of playlists be 0 to 1999. Thus, in a case where the numbers are already exhausted (i.e., file names are exhausted) when a playlist is to be created, editing operations are immediately prohibited regardless of the remaining capacity of the recording medium.

Thus, in the data processing apparatus according to the present invention, considering that the number of play items or the number of playlist marks included in a playlist file already created on a recording medium can have a margin against an upper limit condition, playlists are organized so that the number of playlists on the recording medium is reduced, thereby alleviating the problem of exhaustion of file names regarding playlist files.

For example, when the number of play items or the number of playlist marks has a margin against the upper limit condition as one playlist even when contents of two or more adjacent playlists are combined, the number of playlists on the recording medium can be reduced by integrating these playlists.

Alternatively, by moving data structures forward on a chapter-by-chapter basis from subsequent playlists until a playlist at the beginning reaches an upper limit, a margin against an upper limit condition can be provided in the subsequent playlists regarding the number of play items or the number of playlist marks, so that editing operations can be continued.

Furthermore, a second aspect of the present invention is a computer program written in a computer-readable form so that processing for editing a movie stream recorded on a recording medium according to a predetermined standard format is executed on a computer, characterized in that:

the recording medium has recorded thereon one or more playlist files accompanying a clip movie stream file, the playlist files including chapter information formed of play segments of the clip movie stream and entry points for access to the clip movie stream file by a user, and

the computer program causes the computer to execute

a managing procedure of managing an upper limit condition regarding the playlist files and the chapter information in the playlist files, the upper limit condition being defined in the predetermined standard format; and

an editing procedure of editing the playlist files so that the upper limit condition is reduced.

The computer program according to the second aspect of the present invention defines a computer program written in a computer-readable form so that predetermined processing can be realized on a computer. That is, by installing the computer program according to the second aspect of the present invention on a computer, a cooperative operation is exhibited on the computer, so that the operations and advantages similar to those of the data processing apparatus according to the first aspect of the present invention can be achieved.

### ADVANTAGEOUS EFFECTS

The present invention can provide a favorable data processing apparatus and data processing method and computer program with which it is possible to suitably execute processing for editing a movie stream recorded on a recording medium in accompany with management information according to a predetermined standard format.

The present invention can also provide a favorable data processing apparatus and data processing method and computer program with which it is possible to repeatedly execute operations for editing a movie stream recorded on a recording medium in a complex folder structure according to a predetermined standard format, in consideration of various types of upper limit conditions.

According to the present invention, for example, on a recording medium on which a movie stream and accompanying management information files are recorded according to the AVCHD standard format, by moving play items between playlists or integrating playlists, situations where editing is not allowed or empty files become exhausted due to upper limit conditions can be reduced. Accordingly, cases where the user is not allowed to execute operations such as editing can be reduced.

Further objects, features, and advantages of the present invention will become apparent from the embodiments of the present invention described below or more detailed description based on the accompanying drawings.

### BRIEF DESCRIPTION OF DRAWINGS

FIG. 1 is a diagram schematically showing the internal configuration of a digital video camera 1 according to the present invention.

FIG. 2 is a diagram showing a directory structure of a recording medium 15, defined in the AVCHD standard.

FIG. 3 is a diagram showing an example of a logical data structure for recording user data on the recording medium 15 according to the AVCHD standard in such a form that recording editing is allowed.

FIG. 4A is a diagram for explaining a procedure of generating a playlist together with clips of a movie stream in accordance with recording or image pickup by a digital video camera.

FIG. 4B is a diagram for explaining a procedure of generating a playlist together with clips of a movie stream in accordance with recording or image pickup by a digital video camera.

FIG. 4C is a diagram for explaining a procedure of generating a playlist together with clips of a movie stream in accordance with recording or image pickup by a digital video camera.

FIG. 4D is a diagram for explaining a procedure of generating a playlist together with clips of a movie stream in accordance with recording or image pickup by a digital video camera.

FIG. 5A is a diagram showing an example of processing for moving the last chapter information in a playlist to the beginning of a subsequent playlist.

FIG. 5B is a diagram showing an example of processing for moving the last chapter information in a playlist to the beginning of a subsequent playlist.

FIG. 5C is a diagram showing an example of processing for moving the last chapter information in a playlist to the beginning of a subsequent playlist.

FIG. 6 is a flowchart showing a procedure of processing for moving the last chapter information in a playlist to the beginning of a subsequent playlist.

FIG. 7A is a diagram showing an example of processing for moving the last chapter information in a playlist to the beginning of a new playlist provided in an interval with a subsequent playlist.

FIG. 7B is a diagram showing an example of processing for moving the last chapter information in a playlist to the beginning of a new playlist provided in an interval with a subsequent playlist.

FIG. 7C is a diagram showing an example of processing for moving the last chapter information in a playlist to the beginning of a new playlist provided in an interval with a subsequent playlist.

FIG. 8 is a flowchart showing a procedure of processing for moving the last chapter information in a playlist to the beginning of a new playlist.

FIG. 9 is a flowchart showing a procedure of processing for dividing a play item in a playlist.

FIG. 10A is a diagram showing an example of processing for integrating two adjacent playlists in a playlist.

FIG. 10B is a diagram showing an example of processing for integrating two adjacent playlists in a playlist.

FIG. 11 is a flowchart showing a procedure of processing for integrating two adjacent playlists in a playlist.

FIG. 12A is a diagram showing an example of processing for moving data structures forward from a subsequent playlist to a playlist at the beginning on a chapter-by-chapter basis.

FIG. 12B is a diagram showing an example of processing for moving data structures forward from a subsequent playlist to a playlist at the beginning on a chapter-by-chapter basis.

FIG. 13 is a flowchart showing a procedure of processing for moving data structures forward from a subsequent playlist to a playlist at the beginning on a chapter-by-chapter basis.

### EXPLANATION OF REFERENCE NUMERALS

1 . . . digital video camera
11 . . . camera block
12 . . . encoding/decoding processor
13 . . . stream buffer
14 . . . recorder
15 . . . recording medium
16 . . . CPU
17 . . . temporary storage medium
18 . . . display controller
19 . . . display

### BEST MODES FOR CARRYING OUT THE INVENTION

Embodiments of the present invention will be described below in detail with reference to the drawings.

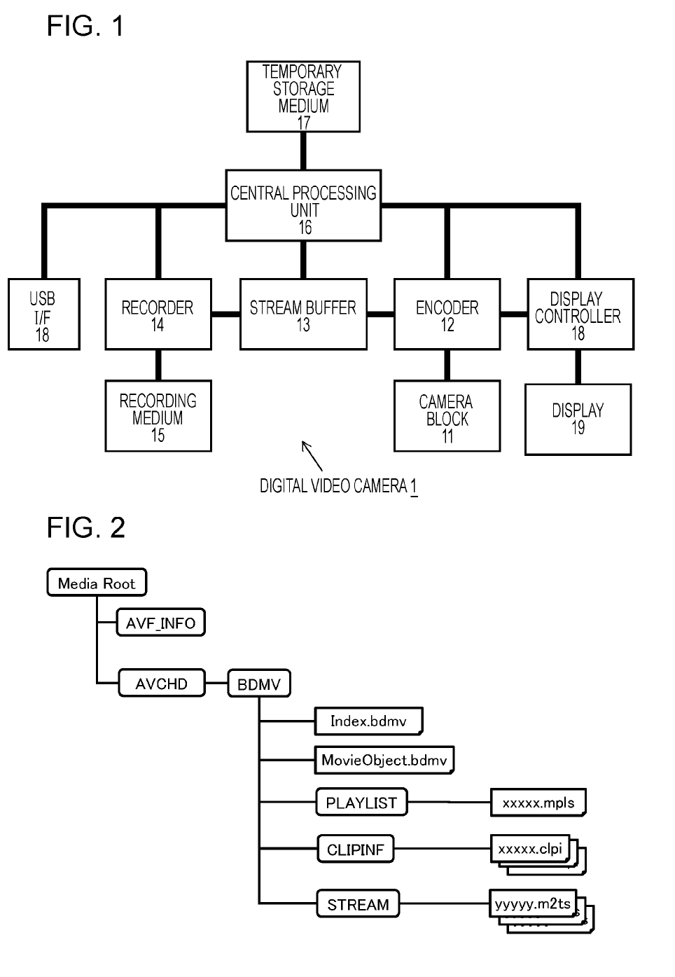

FIG. 1 schematically shows the internal configuration of a data processing apparatus according to the present invention. As shown in the figure, the data processing apparatus is configured as a digital video camera 1, and is configured to encode a movie stream picked up by a camera block 11 into an MPEG2-TS stream by an encoding/decoding processor 12 and to record it on a recording medium 15 provided internally in the device by a recorder 14 according to the AVCHD standard.

A central processing unit 16 exercises overall control on processing operations of the digital video camera 1 as a whole, by a form of loading an execution programs on a temporary storage medium 17 formed by a RAM (Random Access Memory) or the like and executing the programs while temporarily storing system variables and environment variables.

The processing operations by the central processing unit 16 mentioned herein include movie pickup in the camera block 11 and camera work involved in the movie pickup, such as an auto focus function, automatic exposure, handshake correction, and auto shutter, a formatting process of a recording area of the recording medium 15 by the recorder 14, a mounting process of the recording medium 15, recording of a movie stream onto the recording medium 15 and playing of the movie stream, processing for editing a movie stream recorded on the recording medium 15, processing for operation as a USB slave, i.e., a mass storage device (note that this applies to the case of USB connection), and so forth.

The processing for editing of a movie stream on the recording medium 15 includes non-destructive editing, in which only operations such as rearranging the positions of parts or deleting parts that are referred to on a playlist visible to the user so that data of the stream on the recording medium is not edited, and destructive editing, which involves changing the parts themselves on the recording medium. In this embodiment, in order to avoid situations where editing is prohibited or file names are exhausted due to upper limit conditions defined in the AVCHD standard format, processing such as moving play items between playlists or integrating playlists with each other is executed. Such processing will be described later in detail.

The camera block 11 includes a lens for capturing an image of an object, a solid-state image pickup element that generates electronic image signals through photoelectric conversion in accordance with the amount of input light, such as a CCD (Charge Coupled Device) or a CMOS (Complementary Mental-Oxide Semiconductor), an A/D converter that converts the image signals into digital signals, a demosaic processor that calculates RGB signals from the digital image signals, and so forth (not shown). This RGB image is displayed and output from a display 19 via a display controller 18.

The encoding/decoding processor 12 executes processing for encoding and decoding movie streams. More specifically, the encoding/decoding processor 12 encodes a movie stream input from the camera block 11 according to the MPEG2-TS scheme to output an AV stream composed of TS packets having a fixed byte length. The TS packets are temporarily stored in a stream buffer 13 and then transferred to the recorder 14. Upon receiving TS packets at specific time intervals, the recorder 14 records the TS packets on the recording area of the recording medium 15. Furthermore, the encoding/decoding processor 12 executes processing for decoding an encoded movie stream read by the recorder 14 from the recording medium 15, and outputs a play screen from the display 19 via the display controller 18.

The recorder 14 executes recording of files or other management data on the recording medium 15. Furthermore, the recorder 14 can record a movie stream in a format compliant with the AVCHD standard so that a recording editing function is realized. The recording medium 15 referred to herein is, for example, a portable medium such as a DVD or an installed medium such as a hard disk. However, the physical type of the recording medium 15 is not particularly limited as long as it is compliant with the AVCHD standard format.

The display controller 18 controls driving of the display 19. From the display 19, according to instructions from the central processing unit 16, an operation screen (touch panel) for the digital video camera 1 is provided, video image captured by the camera block 11 is displayed and output, or a movie stream decoded by the encoding/decoding processor 12 is played and output.

When connected to a USB master (e.g., a personal computer (not shown) or the like) via a USB cable (not shown) from a USB interface 18, the recorder 14 and the recording medium 15 operate as a USB slave, i.e., as a mass storage device externally connected to the USB master. While the USB connection is maintained, the function as a digital video camera is disabled.

The AVCHD standard is a standard for video cameras, mainly directed to allowing recording of high-definition video signals on low-capacity and low-speed recording media. While inheriting the content of existing disk format standards as appropriate, the AVCHD standard adds recording-compatibility and additional-writing-compatibility functions and defines specification regarding data formats and so forth for HD video cameras. More specifically, when movie content picked up by a video camera is encoded into an MPEG2-TS stream (ClipAVStream) and recorded, various types of accompanying files called playlists (PlayList) and clip information (ClipInformation) are used, so that a recording editing function can be realized suitably.

FIG. 2 shows a directory structure of the recording medium 15, defined in the AVCHD standard. “PLAYLIST”, “CLIPINF”, and “STREAM”, provided directly under a BDMV directory, are subdirectories for storing playlists, clip information files, and clip AV stream files, respectively.

Movie data is recorded as a single movie file in which a set of data forming a unit that needs to be played in such a manner that continuous synchronous playing, i.e., real-time playing, is ensured constitutes one clip (Clip), i.e., a clip AV stream file. The clip AV stream is a file in which a movie stream is stored in the MPEG2-TS format. Furthermore, a clip information file is a file that exists as a pair with the clip AV stream file and in which information regarding a movie stream, needed to play an actual movie stream, is described. Furthermore, a playlist is composed of a plurality of play items (PlayItem). Each play item specifies a play start point (IN point) and a play end point (OUT point) for the clip. In the playlist, play segments and play order of movie data are specified according to a sequence of play items on the time axis.

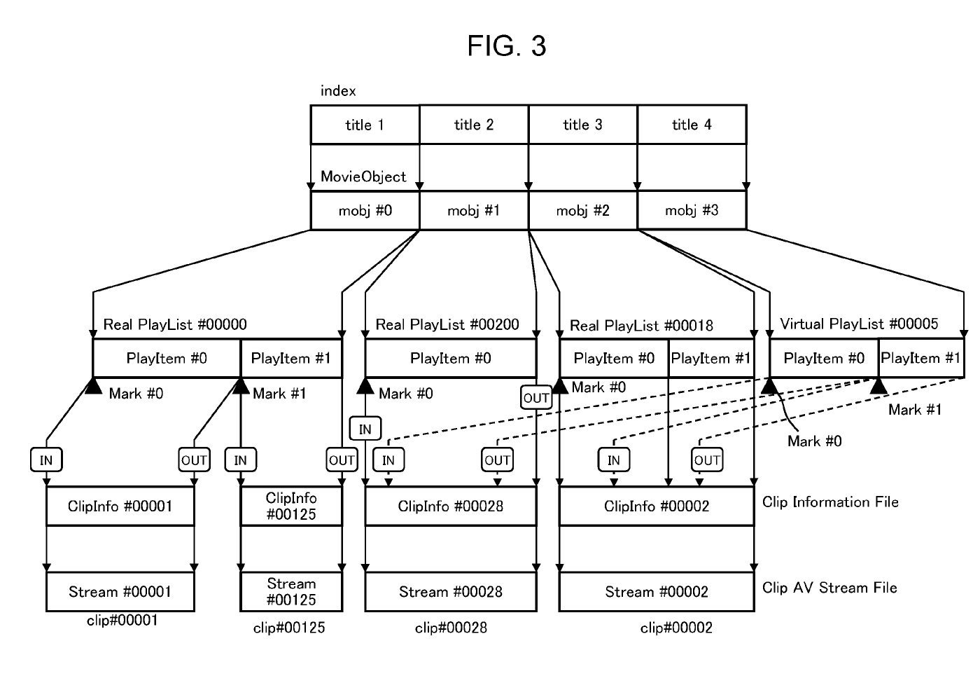

FIG. 3 shows an example of a logical data structure for recording user data on the recording medium 15 in such a format that recording editing is allowed. As shown in the figure, when movie data picked up by the digital video camera 1 is encoded into an MPEG2-TS stream and recorded, files of the types called index (Index), movie object (MovieObject), playlist (PlayList), clip information (ClipInformation), and clip AV stream (ClipAVStream) are used.

TABLE 1

| | Maximum | |
|---|---|---|
| File type | number | Role |
| index | 1 | Base file for managing the entire medium. Manages corresponding relationship between titles |
| | | presented to the user and MovieObject. In the AVCHD format, the play order of playlists, which |
| | | should originally be managed in the MovieObject file, is managed in metadata of the index file. |
| MovieObject | 1 | File that manages playlists that are played when titles are specified. |
| Real PlayList | 2000 in | Playlist for original titles. Video that is recorded and played is registered in order of recording. |
| Virtual PlayList | total | Playlist for creating a user-defined playlist through non-destructive editing. Virtual playlist does not |
| | | have Clip of its own, and specifies and plays Clip registered in one of real playlists. |
| Clip Information | 4000 | Exists as a pair with the Clip AV Stream file, and describes information regarding a stream, needed |
| | | to play an actual stream. |
| Clip AV Stream | 4000 | File storing a stream recorded in MPEG2-TS. AVC image data is saved in this file. |

The entire storage area on the recording medium 15 is managed in a file type layer of the index (index.bdmv). An index file is created for each title presented to the user, thereby managing corresponding relationship with a movie object. The “title (Title)” referred to herein is a set of (user-recognizable) playlists (PlayList), and is generally composed of content of one program or date-based content. In the AVCHD standard format, the play order of playlists, which should originally be managed in the movie object file, is managed in metadata of the index file. Upon loading a recording medium on a player, first, the index is read, so that the user can view titles described in the index.

The movie object is a set of commands for controlling playing. For example, in the existing ROM standard format, the movie object is a file that manages playlists that are played when titles are specified. References to movie objects are listed in the index as entries to titles. However, in the AVCHD format, without reference to the movie object file, relationship between playlists and titles is managed using metadata of the index file.

A playlist is provided in correspondence with a title presented to the user, and is composed of one or more play items (PlayItem). Each play item has a play start point (IN point) and a play end point (OUT point) to specify a play segment thereof. Furthermore, in the playlist, a plurality of play items are arranged on the time axis to specify the play order of individual play segments of the movie stream. Furthermore, play items specifying play segments in different clip AV stream files can be included in one playlist.

Reference relationship between clips and playlists can be set freely. For example, one clip can be referred to from two playlists with different IN points and OUT points. Furthermore, reference relationship between titles and movie objects can be set freely. Playlists are broadly classified into two types, namely, real playlists (RealPlayList) and virtual playlists (VirtualPlayList), according to reference relationship with clips.

A real playlist is a playlist for an original title (a playlist having a body of content), in which play items regarding a movie stream recorded or picked up by a video camera are arranged in order of recording.

A virtual playlist is a playlist for creating a user-defined playlist through non-destructive editing. A virtual playlist does not have clips (AV streams) of its own, and play items in the playlist refer to clips registered in one of the real playlists or partial ranges thereof. That is, the user can cut out play segments as needed from a plurality of clips and collect (copy) the individual play items referring to these play segments to edit a virtual playlist.

A clip is a file of movie data recorded as a set of data forming a unit that needs to be played in such a manner that continuous synchronous playing, i.e., real-time playing, is ensured, and is composed of a clip AV stream file (Clip AV Stream) and a clip information file (Clip Information).

The clip AV stream file as content data is a file storing a movie stream recorded on the recording medium 15 in the MPEG2-TS format. In the AVCHD standard format, a movie stream is stored in this file.

The clip information file is a file that exists as a pair with the clip AV stream file and that defines attributes regarding a movie stream, needed to play an actual movie stream. More specifically, the clip information file includes information defining a method of encoding a movie stream, the size of the movie stream, play time→address conversion, play management information, time map (note that this applies to the case where the recording medium is a DVD), and so forth.

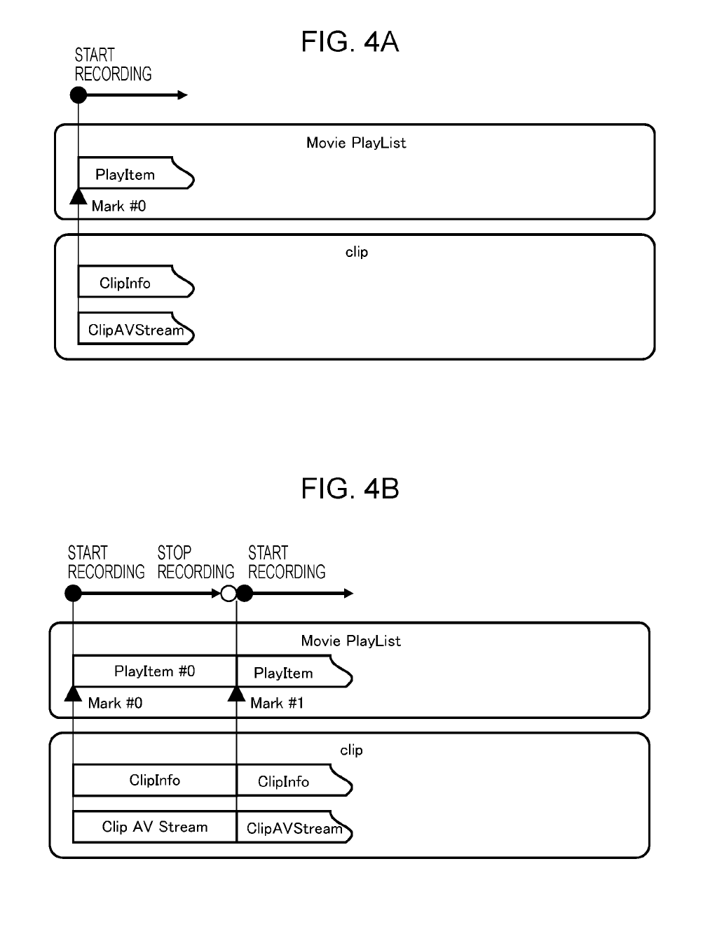

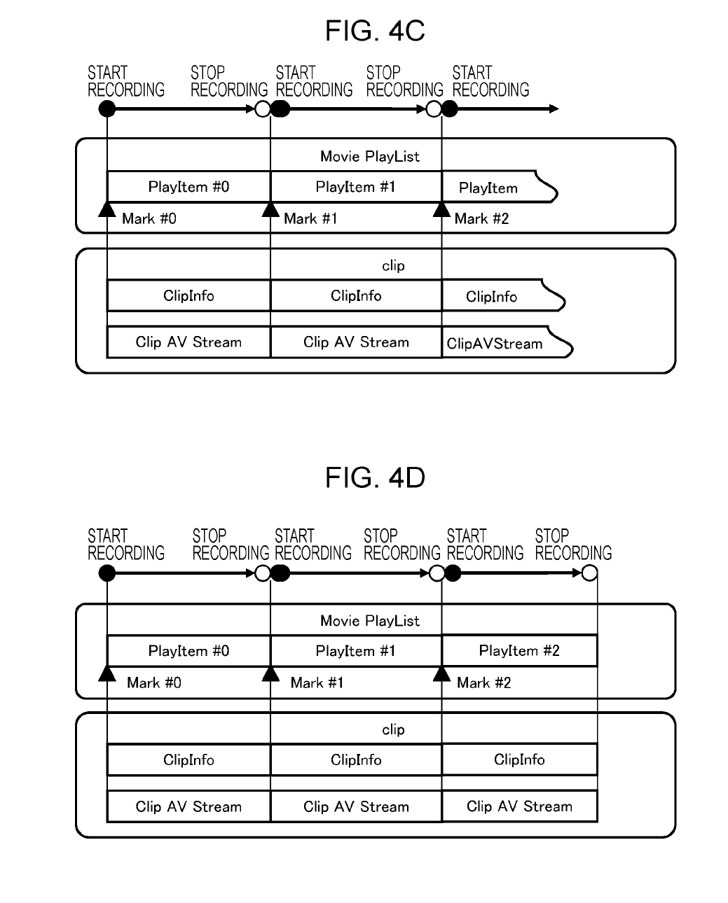

Next, a procedure for generating a playlist together with clips of an AV stream according to an image pickup operation by the digital video camera 1 will be described with reference to FIGS. 4A to 4D.

As shown in FIG. 4A, for each segment from when the user starts recording to when the user stops recording, one play item is created. For example, the segment from when recording is first started to when recording is stopped is registered as a play item having a serial number 0 (PlayItem#0) in a movie playlist (Movie PlayList). Furthermore, the segment from when recording is started next to when recording is stopped is registered as a play item having a serial number 1 (PlayItem#1) in the movie playlist (Movie PlayList), as shown in FIG. 4B (and similarly thereafter).

A real playlist corresponds one to one to a body of content, i.e., a clip AV stream, and each play item registered in a real playlist holds time information of a play start point and a play end point of the corresponding play segment of the clip AV stream. Furthermore, in a movie stream, such as MPEG2-TS, “seamless play”, i.e., continuous play across streams, is allowed by performing encoding so that a predetermined buffer model will not be broken, such as an underflow or overflow of an internal buffer. Each play item (note that this does not apply to the play item at the beginning of the playlist) holds a connection condition with the immediately previous play item (i.e., whether seamless play is allowed or not).

Furthermore, each time the user starts recording, Mark as an entry mark (entry mark) for access to the stream by the user is added at the beginning of a play item (an entry mark in a playlist is also referred to as a “playlist mark (PLM)”). In a playlist, one or more playlist marks exist, each having a role of indicating a specific play position of the clip AV stream. Within one playlist, serial numbers that are sequential along the time axis are assigned to individual playlist marks. Furthermore, each playlist mark registered in the playlist holds a serial number of the play item to which the mark is assigned and timestamp information indicating a play position of the clip AV stream.

One clip AV stream file is formed at the end of a stream that has been recorded or picked up. One clip AV stream serves as a unit that needs to be played in such a manner that continuous synchronous playing, i.e., real-time playing, is ensured. Furthermore, together therewith, a clip information file defining a method of encoding a stream, the size of the movie stream, play time→address conversion, play management information, time map (note that this applies to the case where the recording medium is a DVD), and so forth is created.

Although it is defined that a playlist mark must be inserted at the beginning of a movie playlist (MoviePlayList), through subsequent editing operations, it is possible to move the position of a playlist mark on the time axis or to insert a new playlist mark.

Each playlist mark serves as an entry point for access to the stream by the user. Thus, a segment defined between adjacent entry marks (and a segment from the last playlist mark to the end of the last play item) serves as a minimum editing unit visible to the user, i.e., a “chapter”. By arranging play items according to a play order and arranging playlist marks according to a desired play order, a play order of the segments of the clip AV stream registered in the playlist is defined.

In actual product specifications, a plurality of real playlists is presented together as a sequence of chapters. For example, on an editing screen of a digital video camera, a list of thumbnails of still-picture frames at positions of individual playlist marks defining chapters (or thumbnail movies having play start points at the positions of the playlist marks) is displayed, so that a chapter-based editing environment is provided to the user.

As described earlier, in the AVCHD standard format, as attributes of playlists, in addition to real playlists (Real PlayList) having bodies of content (i.e., clip AV streams), virtual playlists (Virtual PlayList) not having bodies of content are defined. Editing of a virtual playlist involves only redefining a play start point and a play end point for a clip AV file, so that non-destructive editing, which does not change the body of content itself, is allowed.

In many standard formats defining methods of recording files on recording media, upper limit conditions regarding the number of files or the number of folders that can be created on a single recording medium are defined, according to a filename naming rule or the like. By setting such upper limit conditions, for example, the number of files existing on the same path is reduced, thereby achieving an advantage that reduction in access speed is prevented.

For example, in the AVCHD standard described earlier, the following upper limit conditions are defined regarding playlists.

(1) The number of play items is within 999.
(2) The number of playlist marks is within 999.
(3) The sum of file sizes of clip information files that are referred to is within 2 Mbytes.
(4) The sum of EP coarse of clip information files that are referred to is within 24576.
(5) The sum of EP fine of clip information files that are referred to is within 180000.

However, when such upper limit conditions are set in a standard format, in the course of editing content recorded on a recording medium, the number of files can reach the upper limit. When these upper limit conditions are reached on the recording medium, even though the recording medium has a remaining capacity, editing exceeding the upper limit conditions is not allowed. For example, regarding a playlist in which the number of playlist marks has already reached 999, further addition or division of chapters is not allowed, so that the remaining capacity is wasted.

Thus, in this embodiment, when data recorded on a recording medium is edited according to the AVCHD standard, playlists are organized to alleviate the problem of restriction based on the upper limit conditions.

For example, when the number of play items or the number of playlist marks in a playlist has reached or approached the upper limit condition as in (1) or (2) above, processing is executed to move the last (or a predetermined number of from the last) chapter information in the playlist to the beginning of a subsequent playlist.

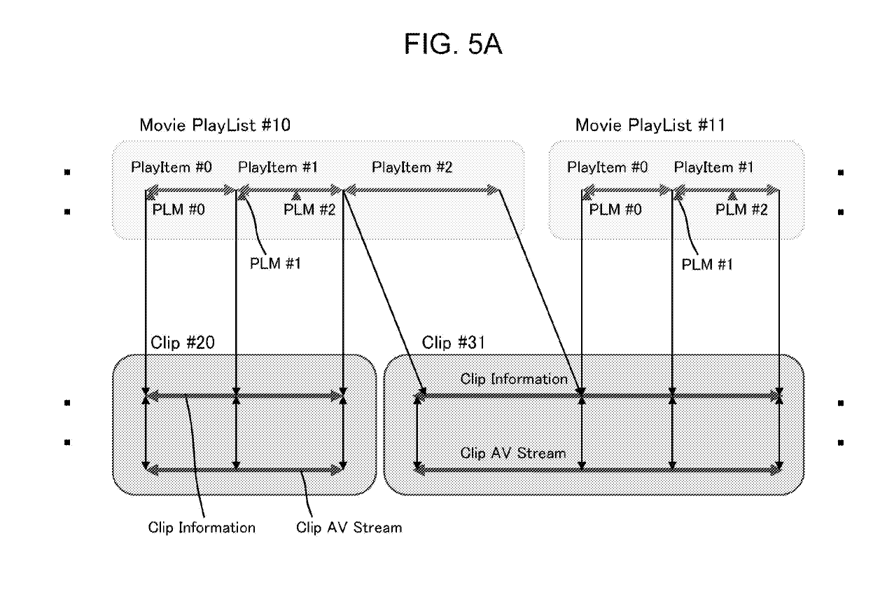

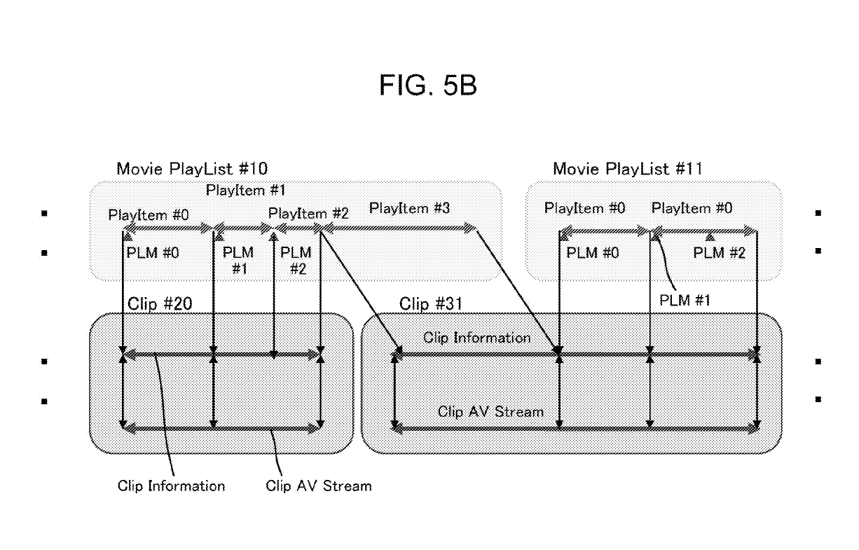

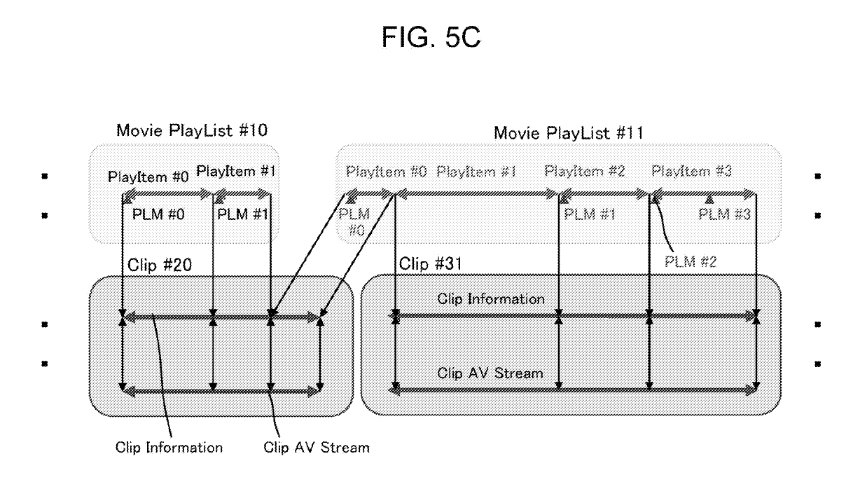

FIG. 5 shows an example of processing for moving the last chapter information in a playlist to the beginning of a subsequent playlist.

As shown in FIG. 5A, in a playlist MoviePlayList#10, PlayItem#0 and PlayItem#1 are registered as play items specifying play segments in Clip#20, and a play item PlayItem#2 specifying a partial play segment of Clip #31 is registered. Furthermore, playlist marks PLM#0, PLM#1, and PLM#2 are inserted respectively at the beginning position of PlayItem#0 and the beginning position and middle position of PlayItem#1.

Furthermore, in a subsequent MoviePlayList#11, PlayItem#0 and PlayItem#1 are registered as play items specifying play segments in Clip #31. Furthermore, playlist marks PLM#0, PLM#1, and PLM#2 are inserted respectively at the beginning position of PlayItem#0 and the beginning position and middle position of PlayItem#1.

Here, processing for moving the last chapter information in the playlist MoviePlayList#10, specified by the playlist mark PLM#2, to the beginning of the subsequent playlist MoviePlayList#11 is executed. In the example shown in FIG. 5A, since the position of the beginning of the chapter that is moved, i.e., the playlist mark PLM#2, does not match a boundary of play items, as preprocessing for moving the chapter, it is necessary to divide a play item at the position of the beginning of the chapter. That is, as shown in FIG. 5B, at the position of inserting the playlist mark PLM#2, the corresponding play item PlayItem#1 is divided, whereby a new play item PlayItem#2 is created.

Then, the play end point of the play item PlayItem#1 is overwritten with the position of the timestamp of the playlist mark PLM#2, the position of the timestamp of the playlist mark PLM#2 is written to the play start point of the new play item PlayItem#2, and the play end point of the original play item PlayItem#2 is written to the play end point of the new play item PlayItem#2. At this time, the new play item PlayItem#2 turns off seamless play as a connection condition of the immediately preceding play item PlayItem#1. Furthermore, in accordance with the division of play items, the identification numbers of play items after the point of division are increased by the number of times of division. In the example shown in FIG. 5B, the original play item PlayItem#2 (refer to FIG. 5A) becomes PlayItem#3.

Then, as shown in FIG. 5C, processing for moving chapter information after the last playlist mark PLM#2 in the movie playlist MoviePlayList#10 to the subsequent playlist PlayList#11 is executed. As shown in the figure, in the playlist MoviePlayList#10, play items PlayItem#0 and PlayItem#1 specifying play segments in Clip#20 remain, and the subsequent play items are moved to the subsequent movie playlist MoviePlayList#11. That is, the play segment in Clip#20 specified by the position of the timestamp of the playlist mark PLM#2 and the partial play segment in Clip#31 specified by the play item PlayItem#3 in FIG. 5B are moved to the beginning of the subsequent movie playlist MoviePlayList#11, and become a play item PlayItem#0 and a play item PlayItem#1 in the same playlist, respectively.

Then, for each of the play items originally included in the movie playlist MoviePlayList#11, the identification number is increased by the number of play items that have been moved from the previous moving playlist MoviePlayList#10, and the identification numbers of play items referred to by the individual playlist marks are also modified. In the example shown in the figure, the play item PlayItem#0 and the play item PlayItem#1 in FIG. 5B become a play item PlayItem#2 and a play item PlayItem#3, respectively, in FIG. 5C after moving the chapter information.

Although not shown, as a result of executing processing for moving the last (or a predetermined number of from the last) chapter information in a playlist to the beginning of a subsequent playlist, the number of play items or the number of playlist marks in the subsequent playlist can reach the upper limit condition. In this case, similar processing can be executed repeatedly to move extra chapter information to a further subsequent playlist.

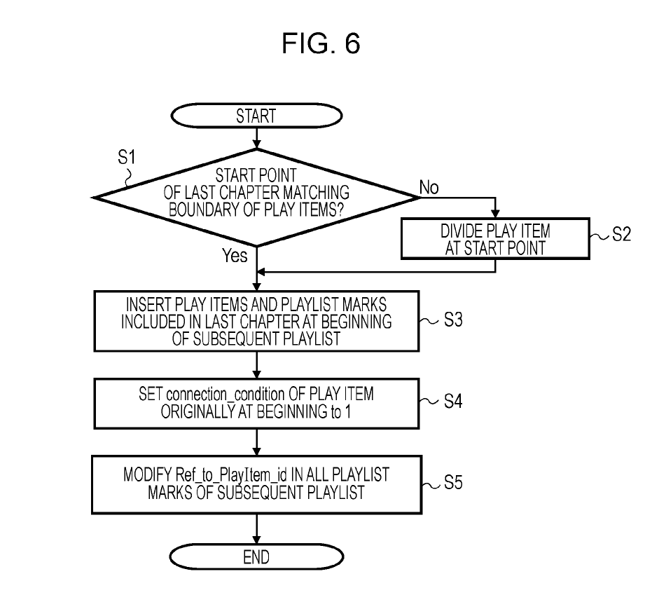

FIG. 6 shows a procedure of processing for moving the last chapter information in a playlist to the beginning of a subsequent playlist, in the form of a flowchart.

First, it is checked whether the start point of the last chapter matches a boundary of play items (step S1). If the start point does not match, the corresponding play item is divided at the start point of the last chapter (step S2).

Then, play items and playlist marks included in the last chapter are inserted at the beginning of the subsequent playlist (step S3).

Then, 1 is written to connection_condition of the play item that has originally been at the beginning in the subsequent playlist, thereby setting the connection condition with the previous play item so that seamless play is not allowed (step S4).

Then, in the subsequent playlist, since the number of play items increases from the beginning in accordance with the chapter information moved from the previous playlist, in all the playlist marks originally included, reference information to identification numbers of play items (Ref_to_PlayItem_id) is modified (step S5).

Alternatively, when the number of play items or the number of playlist marks has reached or approached the upper limit condition as in (1) or (2) above, processing for moving the last (or a predetermined number of from the last) chapter information in a playlist to the beginning of a new playlist may be executed. The play order of the new playlist referred to herein is set in an interval with an existing subsequent playlist.

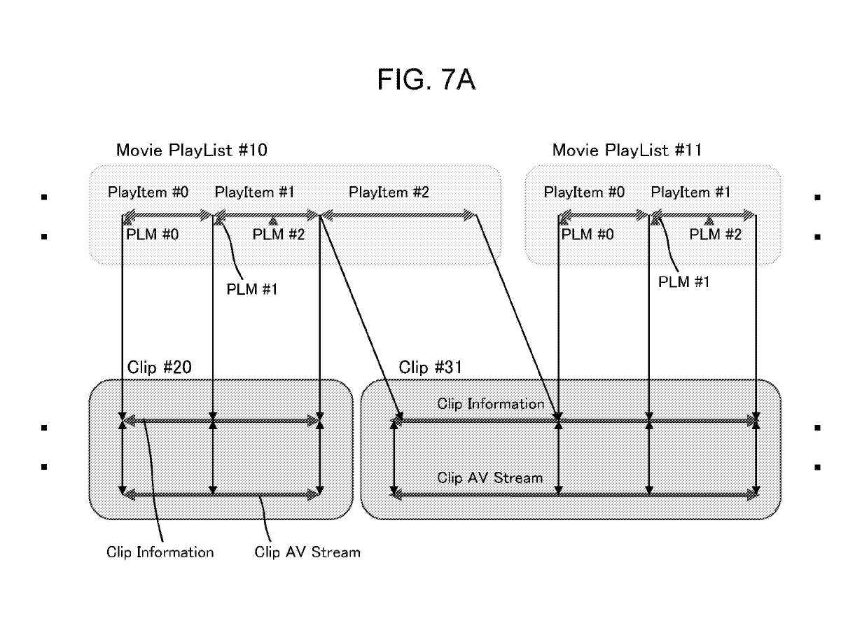

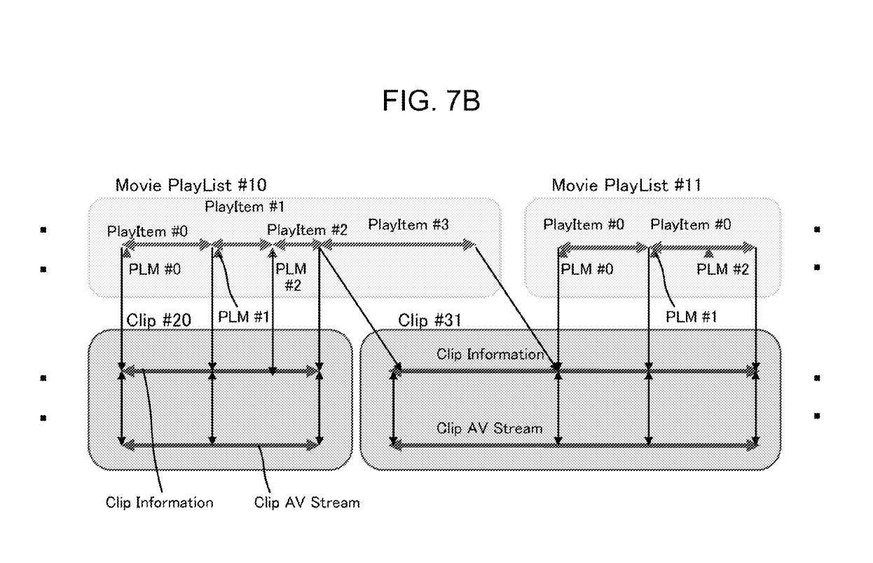

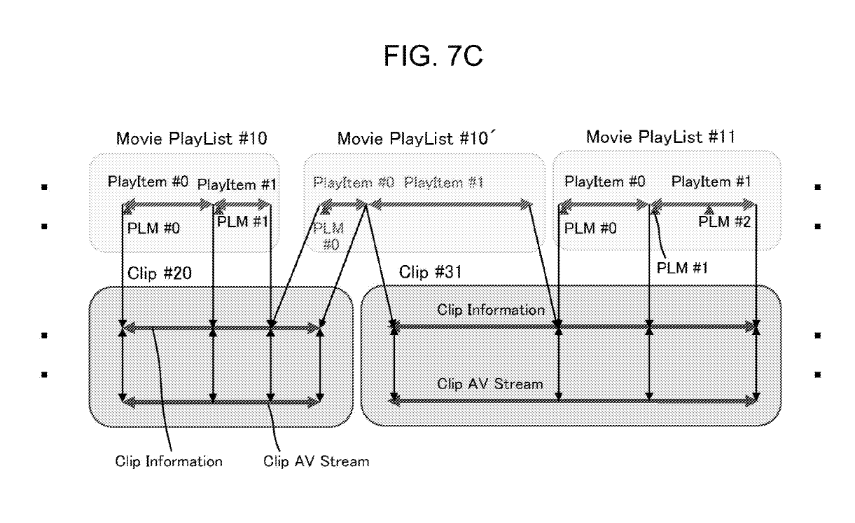

FIG. 7 shows an example of processing for moving the last chapter information in a playlist to the beginning of a new playlist created in an interval with a subsequent playlist.

As shown in FIG. 7A, in a playlist MoviePlayList#10, PlayItem#0 and PlayItem#1 are registered as play items specifying play segments in Clip#20, and a play item PlayItem#2 specifying a partial play segment of Clip #31 is registered. Furthermore, playlist marks PLM#0, PLM#1, and PLM#2 are inserted respectively at the beginning position of the play item PlayItem#0 and the beginning position and middle position of the play item PlayItem#1.

Furthermore, in a subsequent MoviePlayList#11, PlayItem#0 and PlayItem#1 are registered as play items specifying play segments in Clip #31. Furthermore, playlist marks PLM#0, PLM#1, and PLM#2 are inserted respectively at the beginning position of PlayItem#0 and the beginning position and middle position of PlayItem#1.

The last chapter information in the movie playlist MoviePlayList#10, specified by the playlist mark PLM#2, is moved to the beginning of a new playlist MoviePlayList#10′ provided in an interval with the subsequent playlist MoviePlayList#11. In the example shown in FIG. 7A, since the position of the beginning of the chapter that is moved, i.e., the playlist mark PLM#2, does not match a boundary of play items, as preprocessing for moving the chapter, it is necessary to divide a play item at the position of the beginning of the chapter. That is, as shown in FIG. 7B, at the position of insertion of the playlist mark PLM#2, the corresponding play item PlayItem#1 is divided, whereby a new play item PlayItem#2 is created.

Then, the play end point of the play item PlayItem#1 is overwritten with the position of the timestamp of the playlist mark PLM#2, the position of the timestamp of the playlist mark PLM#2 is written to the play start point of the new play item PlayItem#2, and the play end point of the original play item PlayItem#2 is written to the play end point of the new play item PlayItem#2. At this time, the new play item PlayItem#2 turns off seamless play as a connection condition of the immediately previous play item PlayItem#1.

Then, as shown in FIG. 7C, processing for moving chapter information after the last playlist mark PLM#2 in the movie playlist MoviePlayList#10 to the new playlist PlayList#10′ is executed. As shown in the figure, in the movie playlist MoviePlayList#10, play items PlayItem#0 and PlayItem#1 specifying play segments in Clip#20 remain, and the subsequent play items are moved to the new movie playlist MoviePlayList#10. At this time, identification numbers of play items and reference information of playlist marks are updated. That is, the play segment in Clip#20 specified by the position of the timestamp of the playlist mark PLM#2 and the partial play segment in Clip#31 specified by the play item PlayItem#3 in FIG. 7B are moved to the beginning of the new movie playlist MoviePlayList#10′, and become a play item PlayItem#0 and a play item PlayItem#1 in the same playlist, respectively.

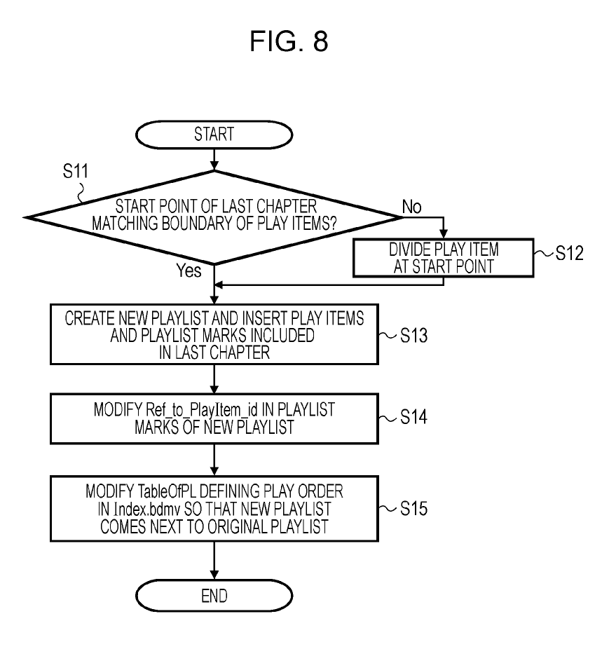

FIG. 8 shows a procedure of processing for moving the last chapter information in a playlist to the beginning of a new playlist, in the form of a flowchart.

First, it is checked whether the start point of the last chapter matches a boundary of play items (step S11). If the start point does not match, the corresponding play item is divided at the start point of the last chapter (step S12).

Then, a new playlist is created between the playlist and the subsequent playlist, and play items and playlist marks included in the last chapter are inserted at the beginning of the new playlist that has been created (step S13).

Then, in the new playlist, identification numbers of the inserted play items and reference information (Ref_to_PlayItem_id) to identification numbers of play items of the individual inserted playlist marks are modified (step S14).

Then, TableOfPL defining a play order in the attribute information file Index.bdmv provided directly under the BDMV directory of the recording medium is modified so that the new playlist comes next to the original playlist (step S15).

In a case where playlists are organized as shown in FIGS. 5 and 7, when chapter information in a playlist is moved to a subsequent (or new) playlist, if the start point of the corresponding chapter (i.e., the position of the timestamp of the playlist mark) does not match a boundary of play items, it is necessary to divide a play item at the start point of the chapter (e.g., step S2 or S12).

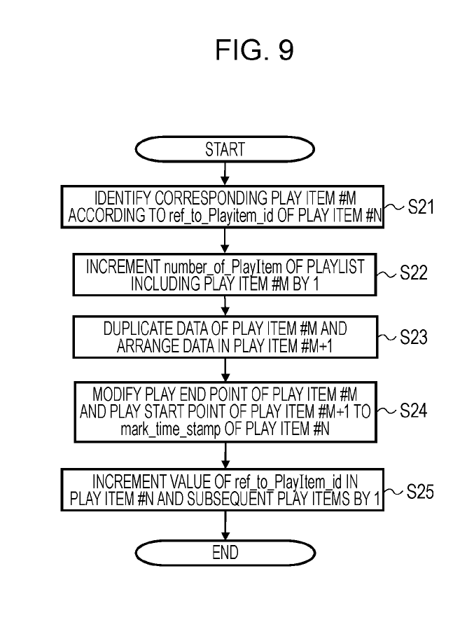

FIG. 9 shows a procedure of processing for dividing a play item in a playlist, in the form of a flowchart. It is to be noted here that a play item PlayItem#M is divided at the position of a playlist mark PLM#N.

First, the play item PlayItem#M corresponding to the chapter that is to be copied is identified on the basis of the serial number (ref_to_Playitem_id) of the play item specified as the source of copying and held by the playlist mark PLM#N (step S21).

Then, before division, the number of play items (number_of_PlayItem) held by the playlist including the corresponding play item PlayItem#M is increased by one (step S22).

Then, data of the play item PlayItem#M is copied, and the copied play item is provided as a play item immediately subsequent to the copy source, i.e., as PlayItem#M+1 (step S23).

Then, the play end point (OUT_time) of the original play item PlayItem#M and the play start point (IN_time) of the copied play item PlayItem#M+1 are both modified to be the timestamp information (mark_time_stamp) held by the point of division, i.e., the playlist mark PLM#N (step S24).

Then, in each playlist after the playlist mark PLM#N at the point of division, the serial number of the play item (ref_to_PlayItem_id) is increased by one (step S25).

In the AVCHD standard, in addition to the upper limit conditions (1) and (2) described earlier defined regarding the number of play items or the number of playlist marks registered in a playlist, it is defined that numbers for file names of playlists be 0 to 1999 on a single recording medium. Thus, in a case where a playlist is to be created but numbers for file names are exhausted (i.e., file names are exhausted) on a recording medium, regardless of the remaining capacity in the recording medium, editing operation is immediately prohibited.

Thus, in this embodiment, considering that the number of play items or the number of playlist marks included in a playlist file already created on a recording medium can have a margin against the upper limit condition, playlists are organized so that the number of playlists on the recording medium is reduced, thereby alleviating the problem of exhaustion of file names.

For example, if the number of play items or the number of playlist marks has a margin against the upper limit condition as one playlist even when two or more adjacent playlists are combined, it is possible to integrate these playlists so that the number of playlists on the recording medium is reduced.

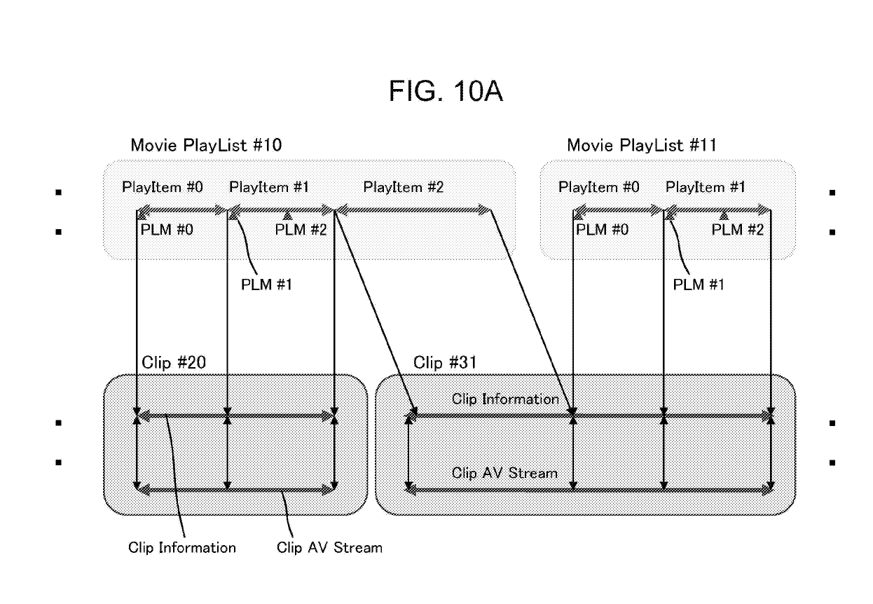

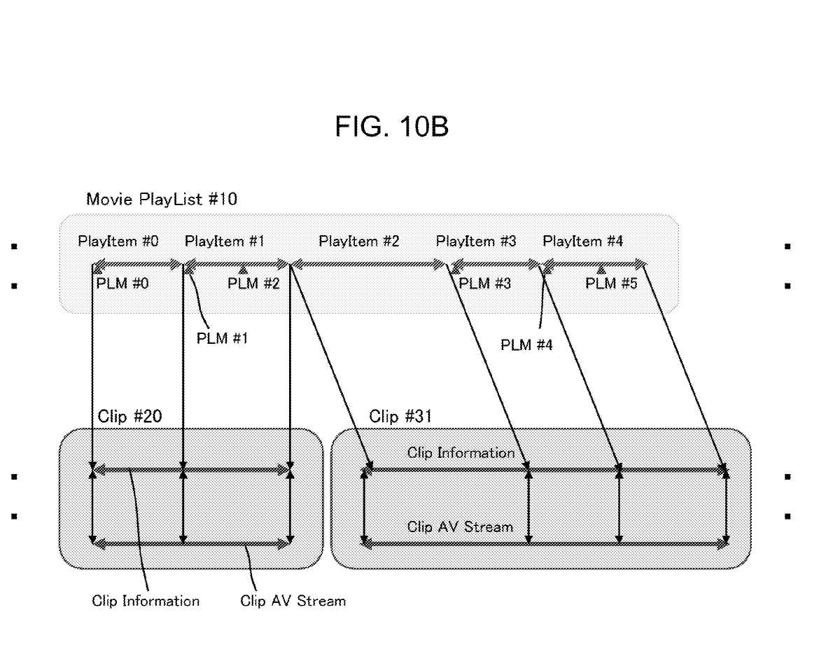

FIG. 10 shows an example of processing for integrating two adjacent playlists in a playlist.

As shown in FIG. 10A, in a playlist MoviePlayList#10, PlayItem#0 and PlayItem#1 are registered as play items specifying play segments in Clip#20, and a play item PlayItem#2 specifying a partial play segment of Clip #31 is registered. Furthermore, playlist marks PLM#0, PLM#1, and PLM#2 are inserted respectively at the beginning position of the play item PlayItem#0 and the beginning position and middle position of the play item PlayItem#1.

Furthermore, in the subsequent MoviePlayList#11, PlayItem#0 and PlayItem#1 are registered as play items specifying play segments in Clip #31. Furthermore, playlist marks PLM#0, PLM#1, and PLM#2 are inserted respectively at the beginning position of the play item PlayItem#0 and the beginning position and middle position of the play item layItem#1.

In a case where the number of play items or the number of playlist marks has a margin against the upper limit condition as one playlist even when the contents of the adjacent movie playlists MoviePlayList#10 and MoviePlayList#11 are combined, these playlists are integrated as one movie playlist MoviePlayList#10, as shown in FIG. 10B.

In accordance with the integration of playlists, chapter information is moved, but information regarding play segments, such as play start points and play end points of the individual play items, need not be changed. Furthermore, processing for dividing a play item for moving chapter information does not occur. However, since playlists or playlist marks in a previous playlist are added at the beginning of a subsequent playlist, playlists and playlist marks included in the subsequent playlist require modification of identification numbers of play items and corresponding modification of reference information of play items of the playlist marks.

In the example shown in FIG. 10B, the play items PlayItem#0 and PlayItem#2 included in the subsequent movie playlist MoviePlayList#11 become play items PlayItem#3 and PlayItem#4, respectively, after the integration. Furthermore, the playlist marks PLM#0, PLM#1, and PLM#2 inserted in the subsequent playlist MoviePlayList#11 become PLM#3, PLM#4, and PLM#5, respectively, after the integration.

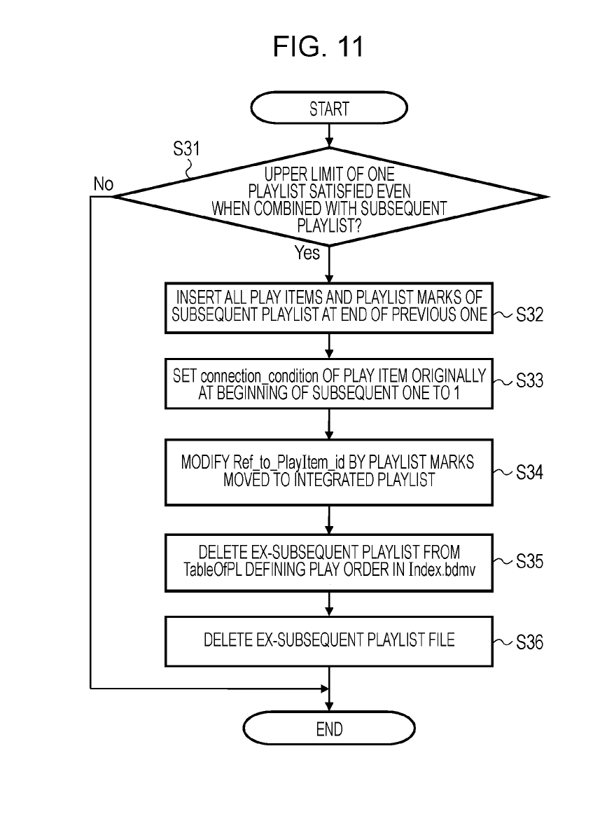

FIG. 11 shows a procedure of processing for integrating two adjacent playlists in a playlist, in the form of a flowchart.

First, it is checked whether the upper limit conditions are satisfied as one playlist even when a playlist that is a subject of processing is integrated with a subsequent playlist (step S31).

If the upper limit conditions are not satisfied (No in step S31), the processing routine is exited. On the other hand, if the upper limit conditions are satisfied (Yes in step S31), all the play items and playlist marks included in the subsequent playlist are inserted at the end of the previous playlist (step S32).

Then, connection_condition of the play item at the beginning of the originally subsequent playlist is set to 1, thereby setting the connection condition with the immediately previous play item so that seamless play is not allowed (step S33).

Then, in the playlist marks moved from the originally subsequent playlist to the integrated playlist, reference information (Ref_to_PlayItem_id) to the corresponding play items is modified (step S34).

Then, from TableOfPL defining a play order in the attribute file Index.bdmv directly under the BDMV directory of the recording medium, description regarding the originally subsequent playlist is deleted (step S35).

Then, the file of the originally subsequent playlist is deleted, and this processing routine is exited (step S36).

Furthermore, by moving data structures forward from subsequent playlists on a chapter-by-chapter basis until the beginning playlist reaches the upper limit conditions, in the subsequent playlists, a margin against the upper limit conditions is provided regarding the number of play items or the number of play list marks, so that editing operations can be continued.

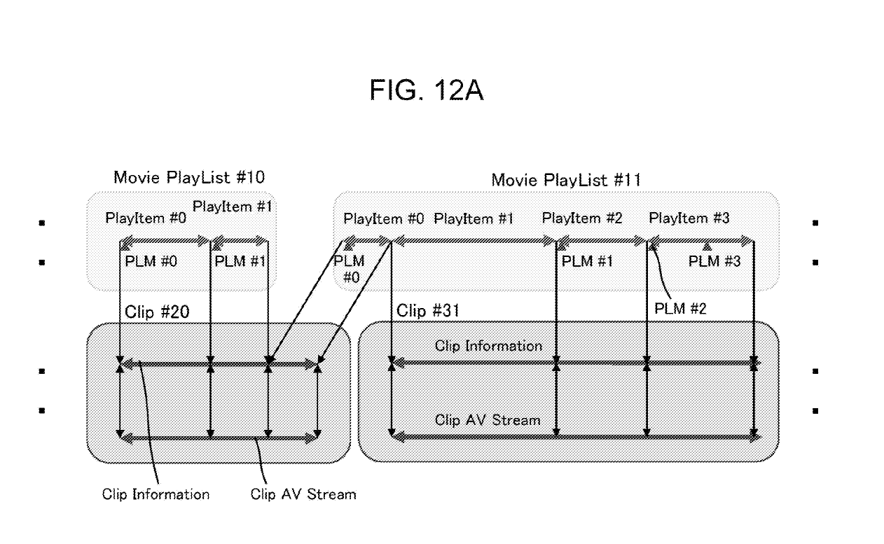

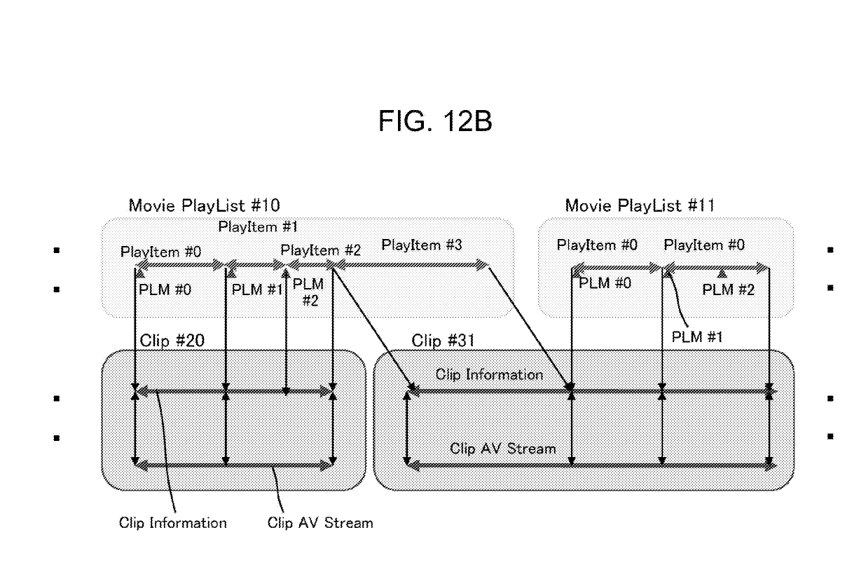

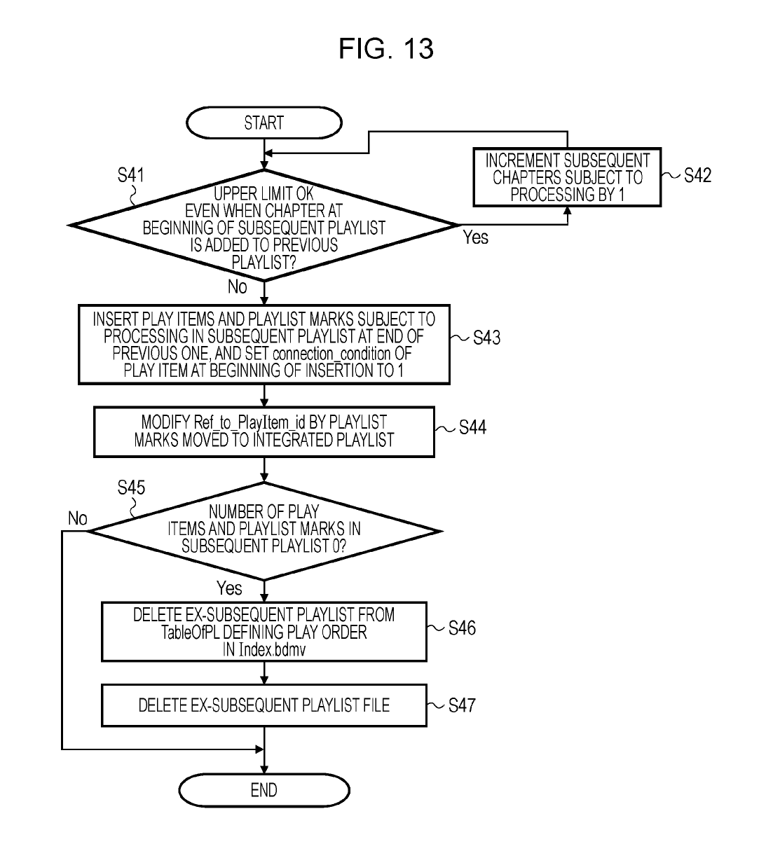

FIG. 12 shows an example of processing for moving data structures forward from subsequent playlists to the beginning playlist on a chapter-by-chapter basis.

As shown in FIG. 12A, in a playlist MoviePlayList#10, PlayItem#0 and PlayItem#1 are registered as play items specifying play segments in Clip#20. Furthermore, playlist marks PLM#0, PLM#1, and PLM#2 are inserted respectively at the beginning position of the play item PlayItem#0 and the beginning position and middle position of the play item PlayItem#1.

Furthermore, in the subsequent MoviePlayList#11, PlayItem#0 specifying a partial play segment in Clip #20, and PlayItem#1, PlayItem#2, and PlayItem#3 as play items specifying individual play segments in Clip#31 are registered. Furthermore, playlist marks PLM#0, PLM#1, PLM#2, and PLM#3 are inserted respectively at the beginning positions of the play items PlayItem#0 and PlayItem#2 and the beginning position and middle position of the play item PlayItem#3.

Here, as shown in FIG. 12B, the chapter information at the beginning of the subsequent movie playlist MoviePlayList#11 is moved to the movie playlist MoviePlayList#10 at the beginning.

When the chapter information is moved, information regarding play segments, such as play start points and play end points of individual play items, need not be changed. Furthermore, processing for division of a play item for moving chapter information does not occur. However, regarding play items moved from the subsequent playlist, since playlists and playlist marks in the previous playlist are added at the beginning, playlists and playlist marks included in the subsequent playlist require modification of identification numbers of play items and corresponding modification of reference information to the play items of the playlist marks. Furthermore, regarding play items and playlist marks remaining in the subsequent playlist, since previous playlists and playlist marks decrease in accordance with the moved chapter information, modification of the identification numbers of play items and corresponding modification of reference information to play items of play list marks are required.

In the example shown in FIG. 12B, the playlists PlayItem#0 and PlayItem#1 moved from the subsequent movie playlist MoviePlayList#11 to the movie playlist MoviePlayList#10 at the beginning become play items PlayItem#2 and PlayItem#3, respectively, in the movie playlist MoviePlayList#10. Furthermore, the playlist mark PLM#0 moved from the subsequent movie playlist MoviePlayList#11 to the movie playlist MoviePlayList#10 at the beginning becomes PLM#2 in the movie playlist MoviePlayList#10. On the other hand, in the subsequent movie playlist MoviePlayList#11, the original play items PlayItem#2 and PlayItem#3 become play items PlayItem#0 and PlayItem#1, respectively, and the playlist marks PLM#1, PLM#2, and PLM#3 become playlist marks PLM#0, PLM#1, and PLM#2, respectively.

FIG. 13 shows a procedure of processing for moving data structures forward from a subsequent playlist to a playlist at the beginning on a chapter-by-chapter basis, in the form of a flowchart.

First, within a range where the upper limit conditions are not reached even when the chapters at the beginning of the subsequent playlist are added to the previous playlist (step S41), chapters that are subjects of processing are increased one by one in the subsequent playlist (step S42).

Then, play items and playlist marks that have become subjects of processing in the subsequent playlist through the loop of steps S41 to S42 are inserted at the end of the previous playlist (step S43). At this time, 1 is written to connection_condition of the play item at the beginning of insertion to set the connection condition with the immediately previous play item so that seamless play is not allowed.

Then, regarding each playlist mark moved from the subsequent playlist to the integrated playlist, reference information (Ref_to_PlayItem_id) to the corresponding play item is modified (step S44).

Here, it is checked whether the number of play items and playlist marks remaining in the subsequent playlist has become 0 (step S45). Here, if any play item and playlist mark not yet integrated in the previous playlist remains in the subsequent playlist, the processing routine is exited.

On the other hand, if no play item and playlist not yet integrated in the previous playlist remain in the subsequent playlist (Yes in step S45), description regarding the originally subsequent playlist is deleted from TableOfPL defining a play order in the attribute file Index.bdmv directly under the BDMV directory of the recording medium (step S46). Then, the originally subsequent playlist file is deleted (step S47), and the processing routine is exited.

### INDUSTRIAL APPLICABILITY

Hereinabove, the present invention has been described in detail with reference to specific embodiments. However, obviously, those skilled in the art can make modifications or alternatives of the embodiments without departing from the gist of the present invention.

The range of application of the present invention is not limited to the AVCHD standard. The present invention can be applied similarly to data processing apparatuses that record management information files accompanied with content files on recording media and that edit recorded content according to various standard formats defining upper limit conditions regarding the number of files or the like on recording media.

That is, the present invention has been disclosed by way of example, and the content described in this specification should not be construed restrictively. The gist of the present invention should be determined with reference to Claims.

1. A data processing apparatus for editing a movie stream recorded on a recording medium according to a predetermined standard format, characterized in that:
the recording medium has recorded thereon one or more playlist files in accompany with a clip movie stream file, the playlist files including chapter information formed of play segments of the clip movie stream and entry points for access to the clip movie stream file by a user, and
the data processing apparatus comprises
managing means for managing an upper limit condition regarding the playlist files and the chapter information in the playlist files, the upper limit condition being defined in the predetermined standard format; and
editing means for editing the playlist files so that the upper limit condition is reduced.

2. The data processing apparatus according to claim 1, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
the editing means executes processing for moving chapter information indicated by a last playlist mark included in a playlist file to the beginning of a subsequent playlist file or a newly created playlist file.

3. The data processing apparatus according to claim 2, characterized in that:
when the position of the last playlist mark included in the playlist file does not match a boundary of play items, the editing means divides a play item at the position of the playlist mark and then executes the processing for moving chapter information.

4. The data processing apparatus according to claim 2, characterized in that:
as a result of executing the processing for moving the chapter information indicated by the last playlist mark included in the playlist file to the beginning of the subsequent playlist file, in a case where an upper limit condition of the number of play items or the number of playlist marks is reached in the subsequent playlist file, the editing means repeatedly executes processing for moving chapter information indicated by a last playlist mark included in the subsequent playlist file to the beginning of a further subsequent playlist file.

5. The data processing apparatus according to claim 1, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
the editing means integrates two adjacent playlist files when the upper limit condition is satisfied as one playlist file even if chapter information included individually in the two adjacent playlist files are combined.

6. The data processing apparatus according to claim 1, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
between two adjacent playlist files, the editing means executes processing for moving chapter information on the beginning side included in a latter playlist file to the end of chapter information in a former playlist file within a range where the chapter information included in the former playlist file satisfies the upper limit condition.

7. A data processing method for editing a movie stream recorded on a recording medium according to a predetermined standard format, characterized in that:
the recording medium has recorded thereon one or more playlist files in accompany with a clip movie stream file, the playlist files including chapter information formed of play segments of the clip movie stream and entry points for access to the clip movie stream file by a user, and
the data processing method comprises
a managing step of managing an upper limit condition regarding the playlist files and the chapter information in the playlist files, the upper limit condition being defined in the predetermined standard format; and
an editing step of editing the playlist files so that the upper limit condition is reduced.

8. The data processing method according to claim 7, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
in the editing step, processing for moving chapter information indicated by a last playlist mark included in a playlist file to the beginning of a subsequent playlist file or a newly created playlist file is executed.

9. The data processing method according to claim 8, characterized in that:
in the editing step, when the position of the last playlist mark included in the playlist file does not match a boundary of play items, a play item is divided at the position of the playlist mark and then the processing for moving chapter information is executed.

10. The data processing method according to claim 8, characterized in that:
in the editing step, as a result of executing the processing for moving the chapter information indicated by the last playlist mark included in the playlist file to the beginning of the subsequent playlist file, in a case where an upper limit condition of the number of play items or the number of playlist marks is reached in the subsequent playlist file, processing for moving chapter information indicated by a last playlist mark included in the subsequent playlist file to the beginning of a further subsequent playlist file is repeatedly executed.

11. The data processing method according to claim 7, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
in the editing step, two adjacent playlist files are integrated when the upper limit condition is satisfied as one playlist file even if chapter information included individually in the two adjacent playlist files are combined.

12. The data processing method according to claim 7, characterized in that:
on the recording medium, a play order of a plurality of playlist files is defined, and in each of the playlist files, as the chapter information, a plurality of play items specifying play segments of the clip movie stream are arranged according to a play order, and playlist marks specifying entry points for access to the clip movie stream file by the user are included, and
in the editing step, between two adjacent playlist files, processing for moving chapter information on the beginning side included in a latter playlist file to the end of chapter information in a former playlist file is executed within a range where the chapter information included in the former playlist file satisfies the upper limit condition.

13. A computer program written in a computer-readable form so that processing for editing a movie stream recorded on a recording medium according to a predetermined standard format is executed on a computer, characterized in that:
the recording medium has recorded thereon one or more playlist files accompanying a clip movie stream file, the playlist files including chapter information formed of play segments of the clip movie stream and entry points for access to the clip movie stream file by a user, and
the computer program causes the computer to execute
a managing procedure of managing an upper limit condition regarding the playlist files and the chapter information in the playlist files, the upper limit condition being defined in the predetermined standard format; and
an editing procedure of editing the playlist files so that the upper limit condition is reduced.
